(19) United States
(12) Patent Application Publication
(10) Pub. No.: US 2018/0165778 A1
(43) Pub. Date: Jun. 14, 2018

(54) Legacy Card

(71) Applicant: Emilyann Leilani Sandan, San Diego, CA (US)

(72) Inventor: Emilyann Leilani Sandan, San Diego, CA (US)

(21) Appl. No.: 15/870,909

(22) Filed: Jan. 13, 2018

Related U.S. Application Data
(63) Continuation-in-part of application No. 15/373,674, filed on Dec. 9, 2016.

(51) Int. Cl. G06Q 50/18; G06Q 10/10

(52) U.S. Cl. CPC G06Q 50/186; G06Q 10/105; G06Q 50/184

(57) ABSTRACT

This invention is directed toward a card that is used by a person wishing to leave a tangible or intangible item to a future recipient and beneficiary(ies). The user creates a Moment online, which is then sealed in a Moment Capsule by a company owning or licensing this invention. The user designates a recipient and beneficiary(ies) of the Moment, and sets a triggering date or event for the Moment to be delivered to the beneficiary. The company creates a physical “Legacy Card” which is mailed to the user and/or the beneficiary or executor, upon which information identifying the Moment is stored. A human resource element reviews each application for a Legacy Card, then refers out any potentially problematic “gifts”, receives advice from an appropriate professional, then incorporates that advice into the search software to improve the product over time.

### CROSS REFERENCE TO RELATED APPLICATIONS

This application claims priority back to U.S. application Ser. No. 15/373,674 filed Dec. 9, 2016 the contents of which are incorporated by reference into this application.

### STATEMENT REGARDING FEDERALLY SPONSORED RESEARCH OR DEVELOPMENT

This invention was not federally sponsored.

### BACKGROUND OF THE INVENTION

### Field of the Invention

This invention relates to a card, referred to generally as a legacy card, and a method of using the legacy card to accomplish a number of desired goals. The basic premise under which the legacy card works is that people would like to leave memories and in some cases items (items that pose no legal risks i.e. securities, intellectual property, avoidance of probate), to others in the future.

The invention includes a software prompt that asks the user creator if there is any legal risk content created as a reminder of the terms of use. The invention applies a software algorithm that scores the user creator content for legal risk levels based on keywords (i.e. securities, 401k, account numbers, countries that are frequently used for hiding assets—Switzerland, Cayman Islands, China, etc.) in English and other languages and additional attributes that signal risk. The algorithm also looks for items that a person may be trying to gift where there are potential problems with the gift, such as intellectual property items such as “patents”, “trademarks” and “copyrights”, or “securities”. The algorithm could even search for estate planning terms which often cause inheritance problems such as “Rule Against Perpetuities”. This algorithm improves on an ongoing basis as it builds a translation memory of risk keywords/attributes to be utilized each time it scores user creator content. Overtime the algorithm becomes more intelligent as it adds keywords/attributes that signal risk. In this case user creator content follows a pathway of levels: Level 1 includes a software prompt, algorithm, and scoring effort. If risk is determined, user creator content is assigned to Level 2 where the appropriate subject matter expert is introduced for guidance and as the subject matter narrows in the exploration of risk additional subject matter experts may be introduced to mitigate risk and ensure that the user creator content intent is legally valid. It is important to note that these risk factors require educated, certified, and credible subject matter experts to provide relevant and valid guidance.

This invention is for the specific use of memory keeping. For example, a grandparent not expecting to live to a grandchild's 50th birthday might want to leave that grandchild a memory or other written document that would be delivered to the grandchild on that grandchild's 50th birthday. There are estate plans that handle the future delivery of assets from a donor to a beneficiary, but these are often done in a purely business transaction manner.

Thus, there exists a need for a means by which people can leave “memories” and gifts to a person, for future delivery, that can be personalized and yet kept safely until the time is ready for their delivery. The current invention provides just such a solution by having a card that is used by a person (user) wishing to leave a tangible or intangible item to a future beneficiary. A company owns or licenses the invention, and allows users to create one or more “Moments” online, which are then sealed in Moment Capsules by the company owning or licensing this invention. The user designates a recipient and beneficiary(ies) for each Moment, and sets a specific date, triggering date or event such as a life event or holiday for the Moment to be delivered to the recipient and beneficiary(ies). The company creates a physical “Legacy Card” which is mailed to the user, upon which information identifying the Moment is stored, and a “Words in Waiting” card that transmits a brief message indicating what may be in the Moment Capsule for the recipient and beneficiary(ies). Through these physical cards, the user sets up a future gift of thoughts, images, video, or even, optionally, tangible assets such as property or money if allowed under that state's laws or through advisement of a bank or other trustee or estate planning attorney who can advise the user appropriately. To ensure that user creator content poses no legal risk, as described in [0001] and [0002] the invention employs a pathway of levels that include a software prompt, intelligent algorithm, risk scoring, and introduction/guidance from subject matter experts.

There has thus been outlined, rather broadly, the more important features of the invention in order that the detailed description thereof may be better understood, and in order that the present contribution to the art may be better appreciated. There are additional features of the invention that will be described hereinafter and which will form the subject matter of the claims appended hereto. The features listed herein and other features, aspects and advantages of the present invention will become better understood with reference to the following description and appended claims. The accompanying drawings, which are incorporated in and constitute part of this specification, illustrate embodiments of the invention and, together with the description, serve to explain the principles of the invention.

It should be understood the while the preferred embodiments of the invention are described in some detail herein, the present disclosure is made by way of example only and that variations and changes thereto are possible without departing from the subject matter coming within the scope of the following claims, and a reasonable equivalency thereof, which claims I regard as my invention.

### BRIEF DESCRIPTION OF THE FIGURES

One preferred form of the invention will now be described with reference to the accompanying drawings.

FIG. 1 is a general flowchart of the invention according to a preferred form of the invention.

FIG. 2 is a flowchart showing how a bank or other trust holder could participate in the legacy process.

FIG. 3 is a flowchart showing how an estate planning attorney could participate in the legacy process.

FIG. 4 is an example of a “Words in Waiting” card.

FIG. 5 is an example of a “Legacy” card.

FIG. 6 is an example of a hard copy Moment being delivered under wax and seal.

### DETAILED DESCRIPTION OF THE FIGURES

Many aspects of the invention can be better understood with references made to the drawings below. The components in the drawings are not necessarily drawn to scale. Instead, emphasis is placed upon clearly illustrating the components of the present invention. Moreover, like reference numerals designate corresponding parts through the several views in the drawings. Before explaining at least one embodiment of the invention, it is to be understood that the embodiments of the invention are not limited in their application to the details of construction and to the arrangement of the components set forth in the following description or illustrated in the drawings. The embodiments of the invention are capable of being practiced and carried out in various ways. In addition, the phraseology and terminology employed herein are for the purpose of description and should not be regarded as limiting.

### BRIEF SUMMARY OF THE INVENTION

A person wanting to create a Legacy Card for a future gift fills out an application, which is reviewed by the Legacy Card's software, which scans it for potential problems, such as terms frequently associated with tax evasion, or items for which “gifting” is often problematic. For example, if the software finds the term “patent”, it would notify the Legacy Card employee of this issue. The Legacy Card employee could review the findings and make a risk assessment and then render a judgement on whether there is not a significant problem (positive judgement) or whether there may be a significant enough problem to warrant referring the issue to an outside professional (negative judgement). In the example of a patent issue, the Legacy Card employee could refer this to an intellectual property attorney, who could then counsel the applicant on making sure any maintenance fees were paid such that the gift of a patent would result in the gift of a valid patent. When the Legacy Card employee refers out a matter to an outside professional, the Legacy Card employee will take the advice rendered by the outside professional and use that to update the searching software, such that the ability of Legacy Card to ferret out problems at an early stage becomes better and better over time.

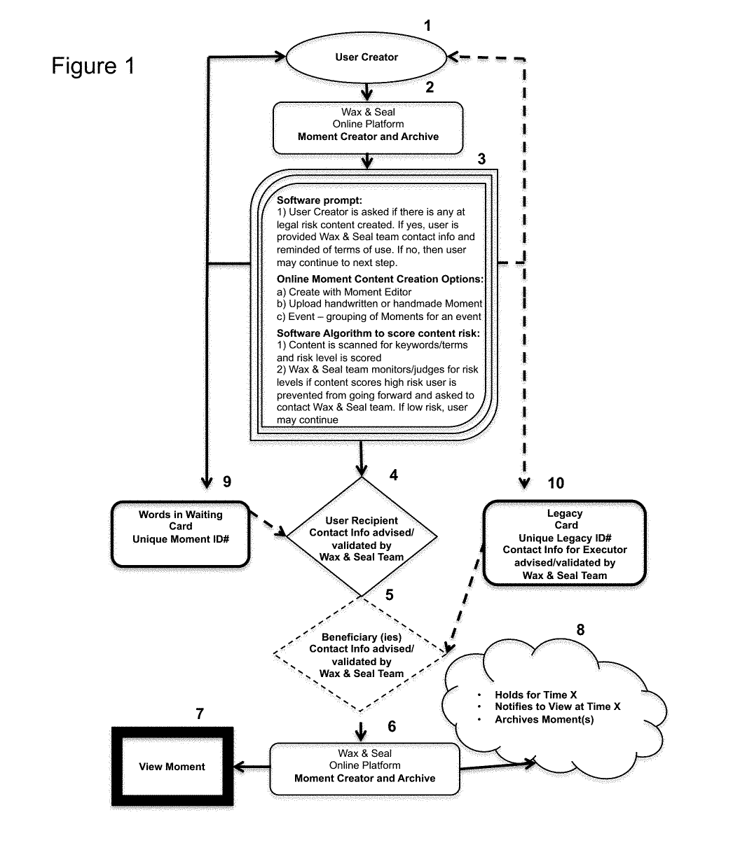

FIG. 1 is a general flowchart of the invention according to a preferred form of the invention. The general goal of the card and the use of the card is to create a personal archive that can become active at a later date to the benefit of another person. The invention proceeds as follows. A user of the invention (1, 11, 22) decides to leave some sort of legacy (10, 20, 31) to another person—the “Recipient” (4, 14, 25) or “Beneficiary(ies)” (5, 15, 26)—and begins by purchasing a “Moment Capsule” or “Moment” (2, 12, 23) from the company that owns the invention or licenses rights to it “the company”. The user receives a software prompt asking if there is any at legal risk content being created (3,13, 24) if yes, user is provided the appropriate contact info or advisement and reminded of terms of use. If no, user may continue to next step. The user (1, 11, 22) then, through the company's online platform (2, 12, 23), creates the “moment” (3, 13, 24) and the moment is stored by the company in electronic format (8, 18, 29). Storing data in electronic format is well known in the industry and this invention includes embodiments using any of the currently available data storage means and methods to create and store these moments. An algorithm is applied to the user creator content to assess risk and provided with a risk score, in cases where risk-score is mid or high a pathway of Levels is employed where specific subject matters are introduced for further guidance on how to proceed legally (3, 13,24). The original designee of the Moment is called the Recipient (4, 14, 25), but the user (1, 11, 22) of the invention can designate additional or alternate beneficiaries (5, 15, 26) as well. Indeed, the invention also contemplates that the original Recipient (4, 14, 25) can even name additional Recipients (4, 14, 25) and/or Beneficiaries (5, 15, 26). To simplify the use of the legacy card (10, 20, 31), all those who are in line to receive a Moment (6, 16, 27) will be referred to as Recipients (4, 14, 25) and Beneficiary(ies) (5, 15, 26)

The “Moment” can be basically anything, ranging from a letter or other personal communication not limited to images and video to a gift or bequest (3, 13, 24) not withstanding any legal risks. The moment can be set to be given to the recipient (4, 14, 25) and beneficiary(ies) (5, 15, 26) at a certain date “To Tom on his 21^{st} birthday” or to be triggered by a certain event “Should Tom marry and have a child, this moment shall trigger on his first child's first birthday” (8, 18, 29). The Moment is not only stored online on the company's database (6, 16, 27), but also sent to the recipient (4, 14, 25) and/or beneficiary(ies) (5, 15, 26), or to some person (such as an estate planning attorney) (32) or entity (such as a bank or trust holder) (21) that has been designated to oversee gifts and other interactions with recipients (4, 14, 25) and beneficiary(ies) (5, 15, 26). Depending on the user's desire (1, 11, 22), the user (1, 11, 22) and even recipient (4, 14, 25) and beneficiary(ies) (5, 15, 26) may have the option to create (3, 13, 24), review (7, 17, 28), search (6, 16, 27), notify for viewing (8, 18, 29), and store Moment Capsules on the platform (6, 16, 27).

The company owning or using this invention (6, 21, 32) provides an online platform where, after the user purchases the Moment Capsule (2, 12, 23), the user (1, 11, 22) can create the moment in a number of ways (3, 13, 24). First, the user (1, 11, 22) can choose from a variety of templates, frameworks and designs supplied by the company and type directly onto the template and/or upload pictures, images, video and other documents (3, 13, 24). Second, the user (1, 11, 22) can personally create the Moment “offline” and then upload the entire moment onto the company's server (3, 13, 24). Third, the user (1, 11, 22) can cooperate with other people to jointly create a grouping of Moments—either offline to be later loaded onto the company's server, or jointly created on the company's templates (3, 13, 24). No matter how the Moment is created, the user(s) (1, 11, 22) can select from a variety of fonts, sizes, colors, clip art, upload other content in other formats, and other known elements in word processing, graphic design, and video production software (3, 13, 24).

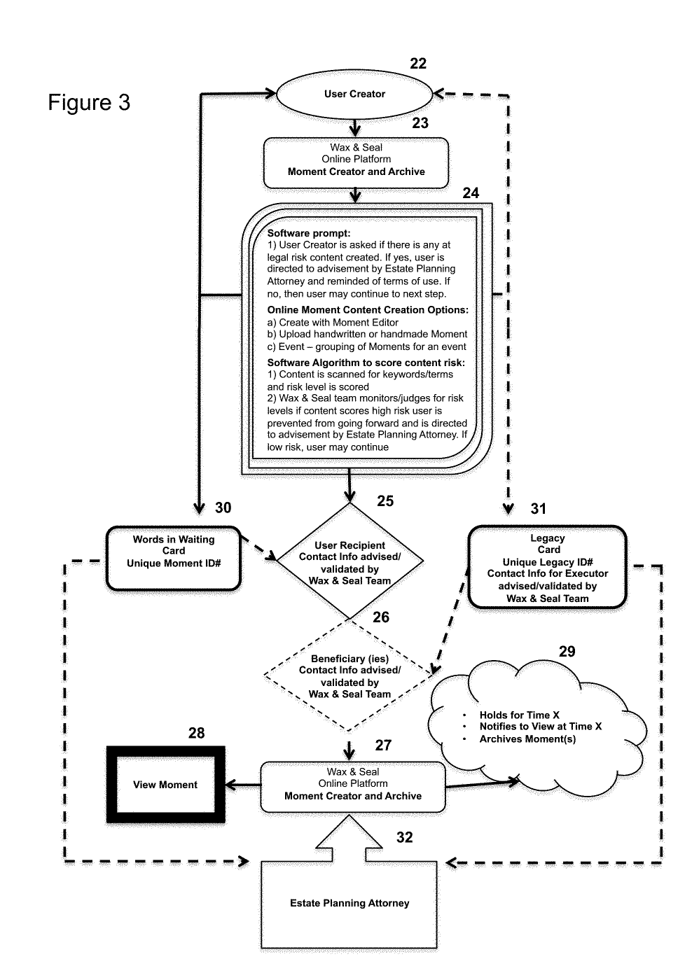

The company has a variety of means, such as docketing software, to “seal” the Moment into a Moment Capsule, which is then scheduled for release (8, 18, 29) to the recipient (4, 14, 25) and beneficiary(ies) (5, 15, 26) at some date in the future (8, 18, 29). As previously mentioned, the future date could be a set date (“Jan. 1, 2025”), such as a certain future date, a birthday, an anniversary, or some other special occasion with a fixed, certain date (8, 18, 29). The date could also be an open-ended future date contingent upon a certain event (“10 years from the day I die”), or a future date contingency upon an uncertain occurrence or occurrence (“10 years from the day I die or the date that Tom marries and has his first child, whichever occurs first”) (8, 18, 29). The Moment Capsule could also be scheduled to be delivered upon random events, and could be delivered in staggered stages as well (8, 18, 29). The role of an estate planner (FIG. 3) comes into play here to avoid the dreaded Rule Against Perpetuities and other estate planning problems.

Users (1, 11, 22) will work with the company to add recipients (4,14, 25) and beneficiaries (5, 15, 26) for future notification of the Moments (8, 18, 29). The company will store, for perpetuity, the Moments in Moment Capsules which can be read/re-read/shared (6, 16, 27) by both the recipients (4, 14, 25) and beneficiaries (5, 15, 26), and for their future generations (6, 16, 27).

The Moment Capsules will be stored on a redundant cloud database for perpetuity, with multiple backups in case of failure of one database (8, 18, 29). Should one of more of the companies storing the Moment Capsules go out of business, the company could contract with an estate planning attorney (32), bank, (21) or other trust holder (21) for that person/organization to step in an either transfer the Moment Capsules to another company, or take over the trust obligations personally.

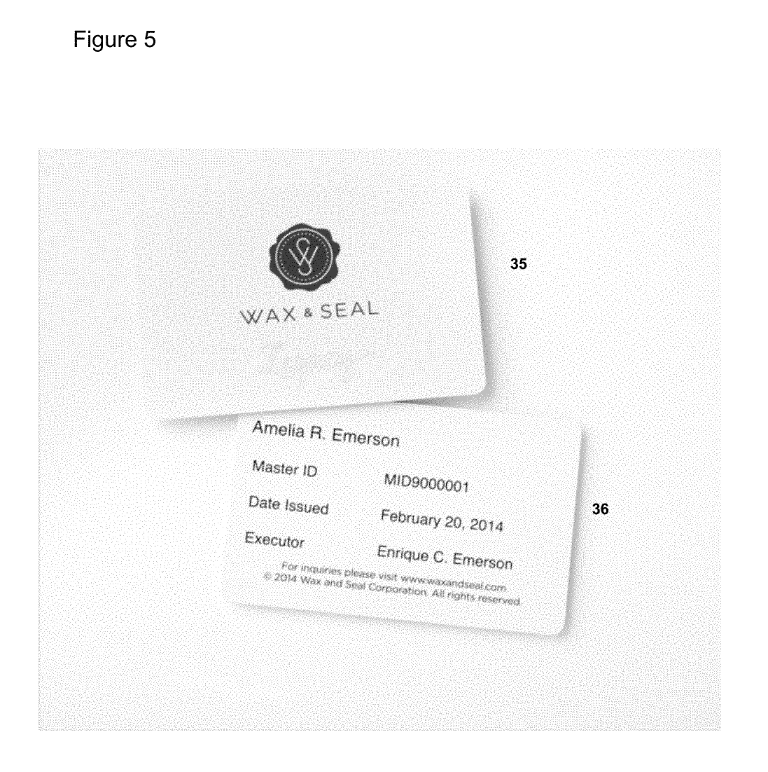

Turning to the actual legacy card itself (10, 20, 31, FIG. 5), the invention contemplates a physical card (35, 36). In a preferred embodiment, the card is the approximate size and shape as a credit card or gift card, but other sizes and shapes are contemplated (FIG. 5). One preferred embodiment calls for the card to be made of plastic, the approximate length, width and height of a credit card, and to have a unique watermark such as a Holokote watermark of the company on it (35, 36). However, it should be stressed that there are no limits to the material make-up of the card and can therefore be made of any physical material as contemplated.

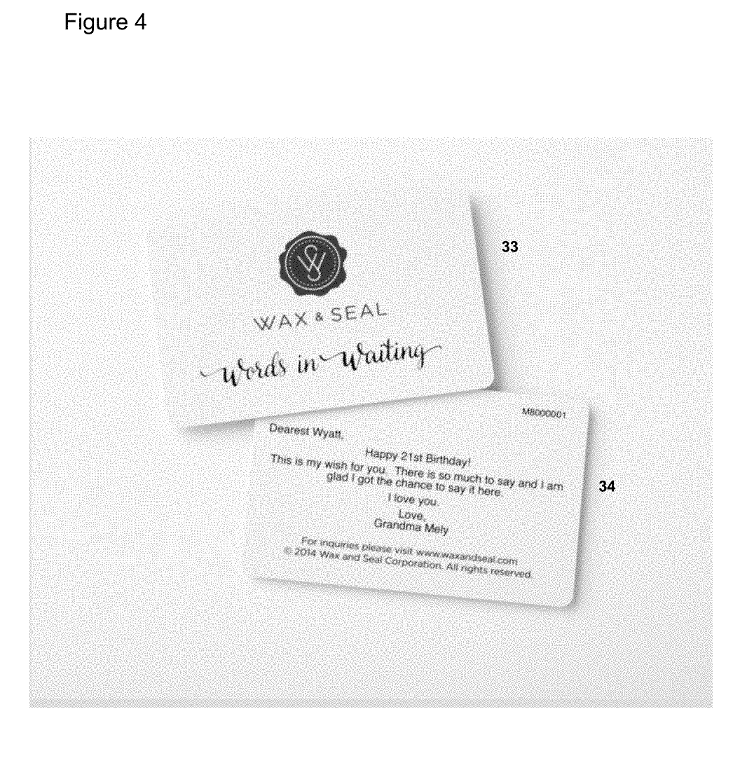

The company then creates a “Words in Waiting” card with a unique identification indicia, such as a number, a scan code, a QR code, or some other known means of personalizing a card (9, 19, 30, FIG. 4, 33, 34). The Words in Waiting card (33,34) serves as physical reminder that the Moments exist on company's database in Moment Capsules (6, 16, 27), and that at least one of these Moment Capsules has been designated for that particular recipient (4, 14, 25) and beneficiary(ies) (5, 15, 26) (multiple recipients are also contemplate, but for sake of simplicity, we are using one recipient for these examples). The physical “card” is created by the company upon finalization and sealing of each Moment Capsule (9, 19, 30, FIG. 4, 33, 34).

Users of the invention (1, 11, 22) will also have the option of ordering a “Legacy Card” from the company (10, 20, 31, FIG. 5). The Legacy Card (10, 20, 31, FIG. 5) will serve as a sort of will/trust card giving notice that Moments from this user exists on the company's database (6, 16, 27), and that Moments will be triggered on a certain date (8, 18, 29). An estate planning attorney (32) or Bank (21) or other trust holder (21) can work with the company to assist in transferring any property or items designated in the Moment Capsule to the recipient (4, 14, 25) and beneficiary(ies) (5, 15, 26). The Legacy Card (10, 20, 31, FIG. 5) will have personal identifiable data and the master customer identification to link all Moment Capsules created by the user (35, 36). The company's database (6, 16, 27) also has means to link all Moment Capsules directed toward a particular recipient (4, 14, 25) and beneficiary(ies) (5, 15, 26).

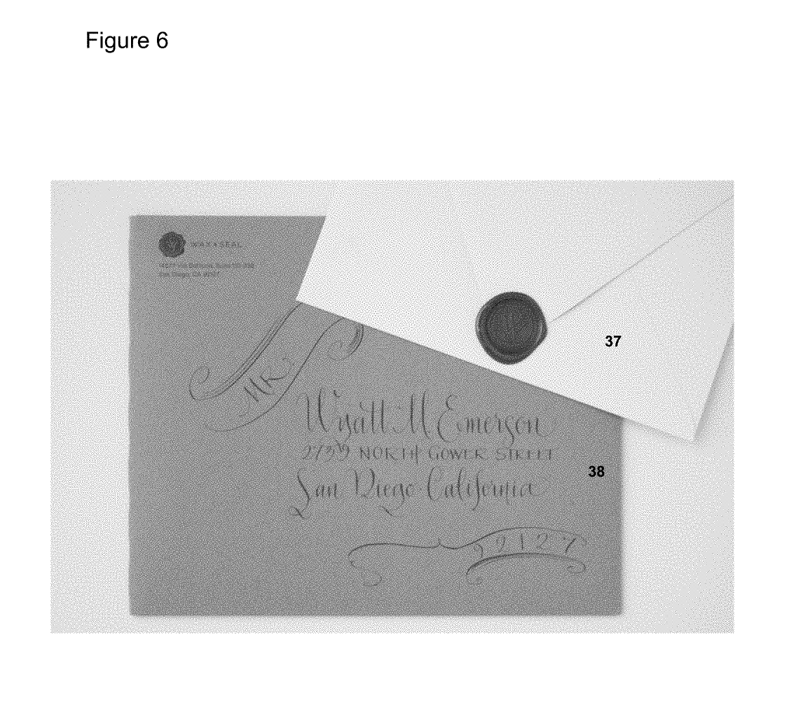

Users (1, 11, 22) will also have the option of ordering a “hard copy” version of the Moment (FIG. 6) to send on the specified date or event (with postal mail timing variations) (8, 18, 29) at an incremental cost to a recipient (4, 14, 25) and beneficiary(ies) (5, 15, 26). Users (1, 11, 22) may also order a hard copy of the Moment to be delivered to them for safe storage as well (FIG. 6, 37, 38). Should the user (1, 11, 22) order a hard copy, the hard copy of the Moment will be physically mailed to the recipient (4, 14, 25) and beneficiary(ies) (5, 15, 26) upon the triggering date (8, 18, 29) printed in paper and sealed in wax (FIG. 6, 37, 38). Other means of making the physical delivery of the Moment more ceremonial, such as messenger delivery, drone delivery, or having the moment delivered to a recipient (4, 14, 25) and beneficiary(ies) (5, 15, 26) place of work, etc. are contemplated. Again, while one preferred embodiment of the invention is used for purposes of illustration, there are no limits to the material make-up of the “hard copy” and can therefore be made of any physical material and delivered by any means to the recipient (4, 14, 25) and beneficiary(ies) (5, 15, 26) as contemplated.

Once the user (1, 11, 22) seals up the Moment in a Moment Capsule (3, 13, 24), the recipient (4, 14, 25) and beneficiary(ies) (5, 15, 26) can, at the option of the user (1, 11, 22), be notified that a Moment for his/her benefit has been created (8, 18, 29). The personal identification of the recipient (4, 14, 25) and beneficiary(ies) (5, 15, 26), such as address, phone number, email address, is provided by the user (1, 11, 22). It is highly advised that the user (1, 11, 22) agree to have the recipient (4, 14, 25) and beneficiary(ies) (5, 15, 26) notified, as this will give notice that a Moment is waiting for him/her, and give the recipient (4, 14, 25) and beneficiary(ies) (5, 15, 26) an incentive to keep the company notified of changes in address, phone number, email address, etc. User recipients (4,14, 25) and beneficiary(ies) contact info will be advised/validated by the Wax & Seal Team, and/or Bank or other Trust Holder, Estate Planning Attorney at routine passing of time in order to maintain the latest and relevant contact info.

The user (1, 11, 22), the recipient (4, 14, 25) and beneficiary(ies) (5, 15, 26) can set reminder preferences with the company to request any other news relating to Words in Waiting (9, 19, 30, FIG. 4), Moments (6, 16, 27) and other notifications (8, 18, 29). Recipients (4, 14, 25) and Beneficiary(ies) (5, 15, 26) will have the option to order from the company a more formalized copy of the Words in Waiting (9, 19, 30, FIG. 4)/Moments (6, 16, 27), such as framed versions, photo books, and other known uses of memorializing events, however the items described are merely for purposes of illustration and not intended to be limiting in any manner—there are no limits to the material make-up of the Moment and can therefore be made of any physical material as contemplated.

Benefits to the user (1, 11, 22) of this invention are considerable. First, because the Moment Capsules are sold on an “as needed” basis, there are not ongoing subscription costs, and no need for a user to put a credit card on file with the company (2, 12, 23). Second, because the company provides a physical card (FIG. 4, 33, 34, FIG. 5, 35, 36) with each Moment Capsule and binds all created Moment Capsules to a Legacy card (FIG. 5, 35, 36), there is less chance that the Moment will be lost in time and no one will remember to activate it (6, 16, 27).

An additional component of the invention can offer a subscription model as an option in the future based on demand.

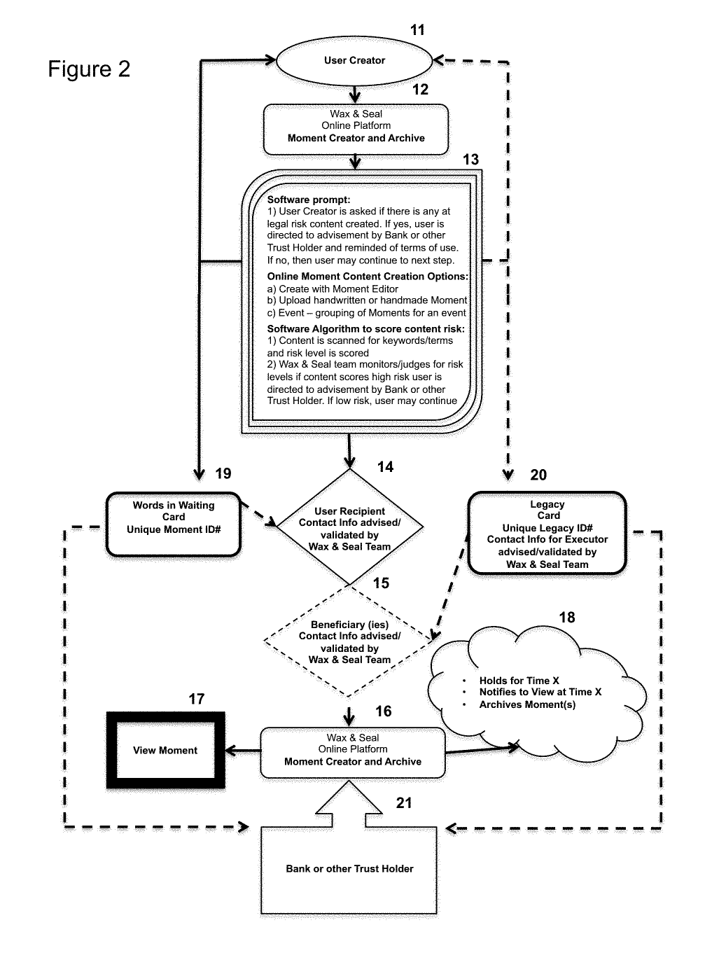

FIG. 2 is a flowchart showing how a bank or other trust holder could participate in the legacy process. In this example, the user (11) of the invention uses a bank (21) or other trust holder (21) to hold any physical or financial aspects of the Moment, such that once the triggering event or date is reached (18), the bank (21) or other trust holder (21) “breaks open” the Moment Capsule and delivers its contents (16) to the recipient (14) and beneficiary(ies) (15). The bank (21) or other trust holder (21) is kept abreast of the issues and events surrounding this particular Moment through the Words in Waiting card (19, FIG. 4, 33, 34) and the Legacy Card (20, FIG. 5, 35, 36) which will permit it access to the company's database (16) with respect to this particular Moment and Moment Capsule (16).

FIG. 3 is a flowchart showing how an estate planning attorney could participate in the legacy process. In this flowchart, an estate planning attorney (32) is used to assist in the designation of assets to be transferred from a user (22) to a recipient (25) and beneficiary(ies) (26), and in the actual release of the assets to the recipient (25) and beneficiary(ies) (26) upon the opening of the Moment Capsule as triggered by a specific date or event (29)

FIG. 4 is an example of a “Words in Waiting” card. On this card, the personalized message that provides a brief indication as to what is stored from the user (FIG. 4, 33, 34) to the recipient (4, 14, 25) and beneficiary(ies) (5, 15, 26) is displayed.

FIG. 5 is an example of a “Legacy” card. The Legacy card displays the unique identification (FIG. 5, 35, 36) for this user (1, 11, 22) and all Moments created. The user can set preferences as to how Moment content will be reviewed by a named Executor (35, 36, 10, 20, 31, 6, 16, 27). For example, the user (1, 11, 22) can decide that he/she would want the Executor (FIG. 5, 35, 36) to have knowledge of the Moments and recipients (4, 14, 25) and beneficiary(ies) (5, 15, 26) but may not want content divulged. The user can set preferences in a number of different ways as to the release of the Moment content (6, 16, 27). Executors (10, 20, 31) contact info will be advised/validated by the Wax & Seal Team and/or Bank or other Trust Holder, Estate Planning Attorney at routine passing of time in order to maintain the latest and relevant contact info.

FIG. 6 is an example of a “hard copy” Moment being delivered under wax and seal (37, 38)

It should be understood that while the preferred embodiments of the invention are described in some detail herein, the present disclosure is made by way of example only and that variations and changes thereto are possible without departing from the subject matter coming within the scope of the following claims, and a reasonable equivalency thereof, which claims I regard as my invention.

All of the material in this patent document is subject to copyright protection under the copyright laws of the United States and other countries. The copyright owner has no objection to the facsimile reproduction by anyone of the patent document or the patent disclosure, as it appears in official governmental records but, otherwise, all other copyright rights whatsoever are reserved.

That which is claimed:

1. A system for distributing content consisting of:
a storage medium
a scheduled delivery component
a software component,
a human resource component, and,
a legacy card,
where the storage medium is a non-transitory computer readable storage medium, where the scheduled delivery component consists of a triggering component, and where the software component consists of both a docketing component and a search component, and additionally comprises a programming logic,
where the docketing component consists of a processor executing programming logic for interfacing with a user, the programming logic configured to accept a user identifier, a recipient identifier, a beneficiary(ies) identifier, a content, and a trigger event; generate a unique identifier; and save the user identifier, the recipient identifier, the beneficiary(ies) identifier, the executor identifier, the content, the trigger event, and the unique identifier to the non-transitory computer readable storage medium;
where the search component scans an application for a Legacy Card submitted by a prospective client for one or more keywords and phrases that have been programmed into the search component to search for one or more risk factors with the application, and renders a risk assessment,
where the human resource element comprises at least one Legacy Card employee who reviews the search component and performs an analysis of the one or more risk factors and the risk assessment, and then renders a judgement on the application, where, based on the judgement rendered by the at least one Legacy Care employee, where a positive review results in the one or more Legacy Care employee approving the application and where a negative review results in the one or more Legacy Card employees taking an additional contact action, where the additional contact action consists of contacting one or more additional professionals who provide one or more items of professional advice to the at least one Legacy Card employee,
and where the at least one Legacy Card employee uses the one or more items of professional advice to update the search component,
and a legacy card, where the legacy card comprises a recipient identifier, a beneficiary(ies) identifier, an executor identifier, a trigger event, and a unique identifier.

2. The system of claim 1, where the risk assessment contains one or more estate planning issues, the at least one Legacy Card employee contacts at least one Estate Planning Attorney, and where the least one Estate Planning Attorney is notified by the at least one Legacy Card employee, and where the at least one Estate Planning Attorney provides an Estate Planning advice to the at least one Legacy Card employee and to the prospective client, where the Estate Planning advice is used by the at least one Legacy Card employee to make a modification to the search component, such that the search component becomes more effective over time.

3. The system of claim 1, where the risk assessment contains one or more intellectual property issues, then at least one Legacy Card employee contacts at least one Intellectual Property Attorney, and where the least one Intellectual Property Attorney is notified by the at least one Legacy Card employee, and where the at least one Intellectual Property Attorney provides an Intellectual Property advice to the at least one Legacy Card employee and to the prospective client, where the Intellectual Property advice is used by the at least one Legacy Card employee to make a modification to the search component, such that the search component becomes more effective over time.

4. The system of claim 1, where the risk assessment contains one or more securities issues, the at least one Legacy Card employee contacts at least one Securities Attorney, and where the least one Securities Attorney is notified by the at least one Legacy Card employee, and where the at least one Securities Attorney provides a Securities Advice to the at least one Legacy Card employee and to the prospective client, where the Securities Advice is used by the at least one Legacy Card employee to make a modification to the search component, such that the search component becomes more effective over time.

5. A system for distributing content comprising:
a storage medium
a scheduled delivery component
a software component,
a human resource component, and,
a legacy card,
where the storage medium is a non-transitory computer readable storage medium, where the scheduled delivery component consists of a triggering component, and where the software component comprises both a docketing component and a search component,
where the docketing component comprises a processor executing programming logic for interfacing with a user, the programming logic configured to accept a user identifier, a recipient identifier, a beneficiary(ies) identifier, content, and a trigger event; generate a unique identifier; and save the user identifier, recipient identifier, beneficiary(ies) identifier, executor identifier, content, trigger event, and unique identifier to the non-transitory computer readable storage medium;
where the search component scans an application for a Legacy Card submitted by a prospective client for one or more keywords and phrases that have been programmed into the search component to search for one or more risk factors with the application, and renders a risk assessment,
where the human resource element comprises at least one Legacy Card employee who reviews the search component and performs an analysis of the one or more risk factors and the risk assessment, and then renders a judgement on the application, where, based on the judgement rendered by the at least one Legacy Care employee, he/she takes an additional contact action when the judgement is a negative judgement, where the additional contact action comprises contacting one or more additional professionals who provide one or more items of professional advice to the at least one Legacy Card employee,
where the one or more items of professional advice provided by the one or more additional professionals is used by the at least one Legacy Card employee to modify the search component, such that the search component is improved over time,
and a legacy card, where the legacy card comprises the recipient identifier, the beneficiary(ies) identifier, the executor identifier, the trigger event, and the unique identifier.

6. The system of claim 5, further comprising a words-in-waiting card, where the words in waiting card comprises a content, and where the trigger event is a specific date.

7. The system of claim 6, wherein the programming logic is further configured to provide access to the content after the trigger event and upon receipt of the recipient identifier, the beneficiary(ies) identifier, and the executor identifier.

8. The system of claim 6, wherein the non-transitory computer readable storage medium comprises a database whereby the programming logic is configured to save the user identifier, the recipient identifier, the beneficiary(ies) identifier, the executor identifier, the content, the trigger event, and the unique identifier to the database.

9. The system of claim 8, where the content comprises a content identifier, where the content identifier references one or more items of tangible personal property, where the recipient identifier is a name of a recipient.

10. The system of claim 8, where the recipient identifier comprises a name and a mailing address of a recipient, and where the address of the recipient primary identifier comprises an electronic mail address.

11. The system of claim 10, wherein the programming logic is further configured to accept a recipient update request, where the recipient update request comprises a second recipient identifier and the unique identifier; and saves the second recipient identifier to the non-transitory computer readable storage medium using the unique identifier, and, where a human resource advises/validate update requests based on time passing.

12. The system of claim 12, where the beneficiary(ies) identifier is a name of a beneficiary(ies).

13. The system of claim 12, where the beneficiary(ies) identifier comprises a name and a mailing address of a beneficiary(ies).

14. The system of claim 5, where the address of the beneficiary(ies) primary identifier comprises an electronic mail address and where the programming logic is further configured to accept a beneficiary(ies) update request, where the beneficiary(ies) update request comprises a second beneficiary(ies) identifier and the unique identifier; and save the second beneficiary(ies) identifier to the non-transitory computer readable storage medium using the unique identifier, and, where a human resource advises and validates the update requests.

15. The system of claim 5, wherein the executor identifier is a name of an executor, wherein the executor identifier comprises of a name and mailing address of an executor, wherein the address of the executor is the primary identifier comprises of an electronic mail address, wherein the programming logic is further configured to accept an executor update request, where the executor update request comprises a second executor identifier and the unique identifier; and save the second executor identifier to the non-transitory computer readable storage medium using the unique identifier, and where a human resource advises and validates update requests, wherein the unique identifier of the legacy card is encoded, wherein the encoded unique identifier of the legacy card is formatted as a barcode, identification number or similar identifier

16. The system of claim 5, where the risk assessment contains one or more estate planning issues, the at least one Legacy Card employee contacts at least one Estate Planning Attorney, and where the least one Estate Planning Attorney is notified by the at least one Legacy Card employee, and where the at least one Estate Planning Attorney provides an Estate Planning advice to the at least one Legacy Card employee and to the prospective client, where the Estate Planning advice is used by the at least one Legacy Card employee to make a modification to the search component, such that the search component becomes more effective over time.

17. The system of claim 5, where the risk assessment contains one or more intellectual property issues, then at least one Legacy Card employee contacts at least one Intellectual Property Attorney, and where the least one Intellectual Property Attorney is notified by the at least one Legacy Card employee, and where the at least one Intellectual Property Attorney provides an Intellectual Property advice to the at least one Legacy Card employee and to the prospective client, where the Intellectual Property advice is used by the at least one Legacy Card employee to make a modification to the search component, such that the search component becomes more effective over time.

18. The system of claim 5, where the risk assessment contains one or more securities issues, the at least one Legacy Card employee contacts at least one Securities Attorney, and where the least one Securities Attorney is notified by the at least one Legacy Card employee, and where the at least one Securities Attorney provides a Securities Advice to the at least one Legacy Card employee and to the prospective client, where the Securities Advice is used by the at least one Legacy Card employee to make a modification to the search component, such that the search component becomes more effective over time.

19. A system for distributing content comprising:
a storage medium
a scheduled delivery component
a software component,
a human resource component, and,
a legacy card,
where the search component scans an application for a Legacy Card submitted by a prospective client for one or more keywords and phrases that have been programmed into the search component to search for one or more risk factors with the application, and renders a risk assessment,
where the human resource element comprises at least one Legacy Card employee who reviews the search component and performs an analysis of the one or more risk factors and the risk assessment, and then renders a judgement on the application, where, based on the judgement rendered by the at least one Legacy Care employee, he/she takes an additional contact action when the judgement is a negative judgement, where the additional contact action comprises contacting one or more additional professionals who provide one or more items of professional advice to the at least one Legacy Card employee,
where the one or more items of professional advice provided by the one or more additional professionals is used by the at least one Legacy Card employee to modify the search component, such that the search component is improved over time,

20. The system of claim 19,
where the storage medium is a non-transitory computer readable storage medium, where the scheduled delivery component consists of a triggering component, and where the software component comprises both a docketing component and a search component,
where the docketing component comprises a processor executing programming logic for interfacing with a user, the programming logic configured to accept a user identifier, a recipient identifier, a beneficiary(ies) identifier, content, and a trigger event; generate a unique identifier; and save the user identifier, recipient identifier, beneficiary(ies) identifier, executor identifier, content, trigger event, and unique identifier to the non-transitory computer readable storage medium,
and, where the legacy card comprises the recipient identifier, the beneficiary(ies) identifier, the executor identifier, the trigger event, and the unique identifier.
